(19) United States
(12) Patent Application Publication
(10) Pub. No.: US 2026/0267450 A1
(43) Pub. Date: Sep. 10, 2026

(54) TOUCH DISPLAY PANEL AND DISPLAY DEVICE

(71) Applicant: Xiamen Tianma Display Technology Co., Ltd., Xiamen (CN)

(72) Inventor: Jinxing Chen, Xiamen (CN)

(73) Assignee: Xiamen Tianma Display Technology Co., Ltd., Xiamen (CN)

(21) Appl. No.: 19/661,781

(22) Filed: Apr. 29, 2026

(30) Foreign Application Priority Data
Jun. 26, 2025 (CN) 202510872786.4

(51) Int. Cl. G06F 3/044; G06F 3/041

(52) U.S. Cl. CPC G06F 3/0446; G06F 3/0412; G06F 3/04164; G06F 3/0445

(57) ABSTRACT

Provided are a touch display panel and a display device. The touch display panel includes a base substrate, a display function layer and a touch function layer that are located on one side of the base substrate. The display function layer includes multiple display units arranged in an array, and a display unit of the multiple display units includes a first display electrode. The touch function layer includes multiple touch units, and a touch unit of the multiple touch units includes a first touch electrode. The operation process of the touch display panel at least includes a touch stage. In the touch stage, first display electrodes of the display units receive a first touch signal, and first touch electrodes of the touch units receive a second touch signal. The first touch signal and the second touch signal each include an alternating current signal.

### CROSS-REFERENCE TO RELATED APPLICATION

The present application claims priority to Chinese Patent Application No. 202510872786.4, filed with the China National Intellectual Property Administration (CNIPA) on June 26, 2025, the disclosure of which is incorporated herein by reference in its entirety.

### TECHNICAL FIELD

Embodiments of the present disclosure relate to the field of display technology and, in particular, to a touch display panel and a display device.

### BACKGROUND

With the development of display technology, more and more display products integrate display and touch functions into the same display panels. The integrated structure of a touch unit and a display unit includes in-cell and on-cell types. The "in-cell" type refers to integrating the touch unit into a display panel, while the "on-cell" type refers to forming the touch unit on a separate touch panel and forming a touch display panel by assembling the touch panel and a display panel.

However, in the touch display panel of the "in-cell" type, a touch electrode of the touch unit and a display electrode of the display unit form a coupling capacitor, which causes a touch signal of the touch electrode and a display signal of the display electrode to interfere with each other, thereby affecting the display effect and touch sensitivity of the touch display panel.

### SUMMARY

The present disclosure provides a touch display panel and a display device to improve the display effect and touch sensitivity of the touch display panel.

In a first aspect, the present disclosure provides a touch display panel. The touch display panel includes a base substrate, a display function layer and a touch function layer that are located on one side of the base substrate.

The display function layer includes multiple display units arranged in an array, and a display unit of the multiple display units includes a first display electrode.

The touch function layer includes multiple touch units, and a touch unit of the multiple touch units includes a first touch electrode.

An operation process of the touch display panel at least includes a touch stage.

In the touch stage, multiple first display electrodes of the multiple display units receive a first touch signal, and multiple first touch electrodes of the multiple touch units receive a second touch signal; the first touch signal and the second touch signal each include an alternating current signal.

In a second aspect, the present disclosure further provides a display device including the preceding touch display panel.

### BRIEF DESCRIPTION OF DRAWINGS

FIG. 1 is a top view of a touch display panel according to embodiments of the present disclosure.

FIG. 2 is a diagram illustrating the film structure of a touch display panel according to embodiments of the present disclosure.

FIG. 3 is a diagram illustrating the structure of a display unit according to embodiments of the present disclosure.

FIG. 4 is another diagram illustrating the film structure of a touch display panel according to embodiments of the present disclosure.

FIG. 5 is a diagram illustrating the film structure of a touch display panel according to embodiments of the present disclosure.

FIG. 6 is a diagram illustrating the film structure of a touch display panel according to embodiments of the present disclosure.

FIG. 7 is another top view of a touch display panel according to embodiments of the present disclosure.

FIG. 8 is another top view of a touch display panel according to embodiments of the present disclosure.

FIG. 9 is another diagram illustrating the film structure of a touch display panel according to embodiments of the present disclosure.

FIG. 10 is another top view of a touch display panel according to embodiments of the present disclosure.

FIG. 11 is a drive timing diagram of a touch display panel according to embodiments of the present disclosure.

FIG. 12 is another drive timing diagram of a touch display panel according to embodiments of the present disclosure.

FIG. 13 is another drive timing diagram of a touch display panel according to embodiments of the present disclosure.

FIG. 14 is another drive timing diagram of a touch display panel according to embodiments of the present disclosure.

FIG. 15 is another drive timing diagram of a touch display panel according to embodiments of the present disclosure.

FIG. 16 is another drive timing diagram of a touch display panel according to embodiments of the present disclosure.

FIG. 17 is another top view of a touch display panel according to embodiments of the present disclosure.

FIG. 18 is another drive timing diagram of a touch display panel according to embodiments of the present disclosure.

FIG. 19 is another top view of a touch display panel according to embodiments of the present disclosure.

FIG. 20 is another top view of a touch display panel according to embodiments of the present disclosure.

FIG. 21 is another drive timing diagram of a touch display panel according to embodiments of the present disclosure.

FIG. 22 is another drive timing diagram of a touch display panel according to embodiments of the present disclosure.

FIG. 23 is another drive timing diagram of a touch display panel according to embodiments of the present disclosure.

FIG. 24 is another drive timing diagram of a touch display panel according to embodiments of the present disclosure.

FIG. 25 is another drive timing diagram of a touch display panel according to embodiments of the present disclosure.

FIG. 26 is another top view of a touch display panel according to embodiments of the present disclosure.

FIG. 27 is another top view of a touch display panel according to embodiments of the present disclosure.

FIG. 28 is another top view of a touch display panel according to embodiments of the present disclosure.

FIG. 29 is another drive timing diagram of a touch display panel according to embodiments of the present disclosure.

FIG. 30 is a diagram illustrating the structure of a display device according to embodiments of the present disclosure.

FIG. 31 is another diagram illustrating the structure of a display device according to embodiments of the present disclosure.

FIG. 32 is another diagram illustrating the structure of a display device according to embodiments of the present disclosure.

### DETAILED DESCRIPTION

To make the objects, technical solutions, and advantages of the present disclosure clearer, the technical solutions of the present disclosure are described completely below in conjunction with the drawings in embodiments of the present disclosure and specific implementations. Apparently, the embodiments described below are part, not all, of the embodiments of the present disclosure. It is apparent for those skilled in the art that various modifications and variations can be made in the present disclosure without departing from the spirit or scope of the present disclosure. Therefore, the present disclosure is intended to cover modifications and variations of the present disclosure that fall within the scope of the corresponding claims (the claimed technical solutions) and equivalents thereof.

Moreover, the terms "first", "second", and the like in the present disclosure are used for distinguishing between different components but not used for describing any order, quantity, or significance. Similarly, the term "one", "a", "the", or the like does not mean a quantitative limit, but indicates the existence of at least one. The term "including", "comprising", or the like means that the elements or objects in front of the term cover elements or objects and their equivalents listed in the back of the term, but does not exclude other elements or objects. The term "connect", "connected to", or the like is not limited to a physical or mechanical connection, but may include an electrical connection, whether it is direct or indirect. "On", "below", "left", "right", and the like are utilized to indicate the relative positional relationship, and when the absolute position of the described object is changed, the relative positional relationship may also change accordingly. In addition, the description of being the same and equal involved in the embodiments of the present disclosure does not indicate that two objects are completely equal in size and the same in shape. The two objects are allowed to be approximately the same or approximately equal within a certain error range.

It is to be noted that if not in collision, the embodiments of the present disclosure may be combined with each other.

A touch display panel typically includes a touch unit and a display unit. The display unit may include a display electrode. The display unit can be controlled to display light emission by supplying a display signal to the display electrode so that the touch display panel can present a corresponding displayed image. The touch unit may include a self-capacitive touch electrode or a mutual-capacitive touch electrode. A capacitor is formed between the self-capacitive touch electrode and the ground, or a capacitor is formed between a touch sensing electrode and a touch driving electrode in the mutual-capacitive touch electrode. When a finger or a stylus touches the touch surface of the touch display panel, a capacitor of the touch unit changes. A touch position can be detected by the amount of change in the capacitor so that human-computer interaction can be enabled for the touch display panel.

However, in the case where a touch unit is embedded into a display panel to form a touch display panel, in the touch display panel, the distance from a touch electrode of a touch unit to a display electrode of a display unit is relatively close so that a capacitor is also formed between the touch electrode and the display electrode. In this case, due to the coupling effect of the capacitor, a signal of the display electrode is coupled to the touch electrode, affecting the accuracy of a signal on the touch electrode and thereby affecting the accuracy and sensitivity of detecting a touch position when the touch position is detected. Moreover, in the touch stage, a touch signal supplied to the touch electrode is also coupled to the display electrode, thereby affecting the accuracy of the signal on the display electrode and further affecting the display light-emitting state of the display unit and the display effect of the touch display panel.

To solve the preceding technical problems, embodiments of the present disclosure provide a touch display panel. The touch display panel includes a base substrate, a display function layer and a touch function layer that are located on one side of the base substrate. The display function layer includes multiple display units arranged in an array, and a display unit of the multiple display units includes a first display electrode. The touch function layer includes multiple touch units, and a touch unit of the multiple touch units includes a first touch electrode. The operation process of the touch display panel at least includes a touch stage. In the touch stage, first display electrodes of the display units receive a first touch signal, and first touch electrodes of the touch units receive a second touch signal. The first touch signal and the second touch signal each include an alternating current signal.

With the preceding technical solutions adopted, the display function layer and the touch function layer are arranged on the side of the base substrate, the display function layer includes the multiple display units arranged in an array, and the touch function layer includes the multiple touch units so that the display units can be controlled for display, satisfying the image display requirement of the touch display panel, and the touch function can be fulfilled through the touch units, satisfying the interaction requirement of the touch display panel. Moreover, in the touch stage of the touch display panel, the first display electrodes of the display units are controlled to receive the alternating current first touch signal, and the first touch electrodes of the touch units are controlled to receive the alternating current second touch signal, that is, the first display electrodes and the first touch electrodes receive the alternating current signals in the touch stage, so that the signal type on the first display electrodes can remain consistent with the signal type on the first touch electrodes, and signals coupled from the first display electrodes to the first touch electrodes can remain consistent with signals coupled from the first touch electrodes to the first display electrodes, so as to ameliorate the case where a difference in the signal types received by the first display electrodes and the first touch electrodes in the touch stage causes the signals of the first display electrodes to affect the signals of the first touch electrodes and causes the signals of the first touch electrodes to affect the signals of the first display electrodes, thereby improving the touch sensitivity of the touch display panel and the display effect of the touch display panel.

The preceding is the core idea of the present disclosure. Based on the embodiments of the present disclosure, all other embodiments obtained by those of ordinary skill in the art are within the scope of the present disclosure on the premise that no creative work is done. The technical solutions in the embodiments of the present disclosure are described clearly and completely in conjunction with the drawings in the embodiments of the present disclosure.

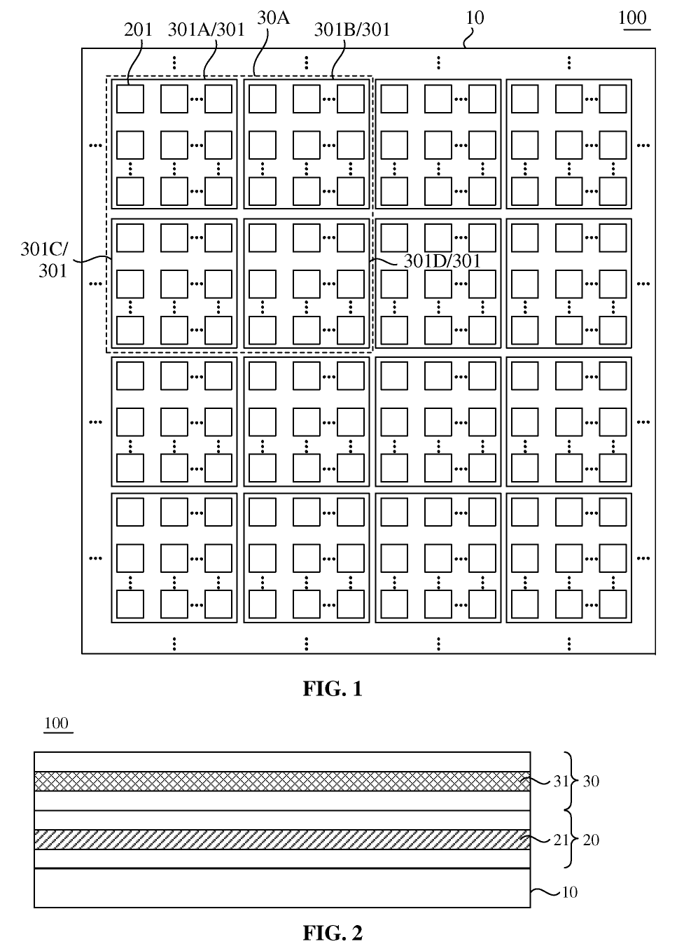

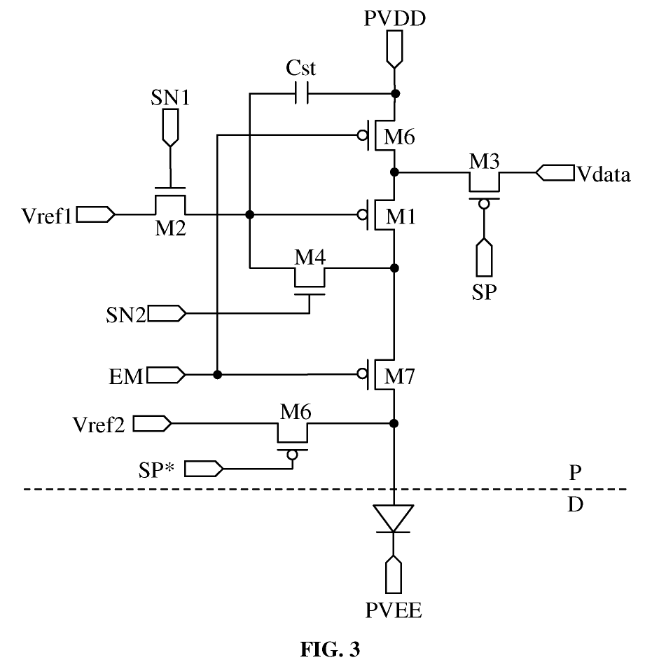

FIG. 1 is a top view of a touch display panel according to embodiments of the present disclosure. FIG. 2 is a diagram illustrating the film structure of a touch display panel according to embodiments of the present disclosure. Referring to FIGS. 1 and 2, the touch display panel 100 includes a base substrate 10 and a display function layer 20 located on one side of the base substrate 10. The display function layer 20 includes multiple display units 201 arranged in an array. A display unit 201 of the multiple display units 201 includes a first display electrode 21.

The base substrate 10 may be rigid or flexible. When being a rigid base substrate, the base substrate 10 may include a glass substrate or the like. When being a flexible base substrate, the base substrate 10 may include a flexible organic layer or an ultra-thin glass layer, or the like. The specific structure of the base substrate 10 may be designed according to actual requirements, which is not specifically limited in the embodiments of the present disclosure.

It is to be understood that the touch display panel 100 may be either a self-luminous display panel or a non-self-luminous display panel, which may be specifically designed according to actual requirements and is not specifically limited in the embodiment of the present disclosure.

In conjunction with FIGS. 1 and 3, when being the self-luminous display panel, the touch display panel 100 may include, for example, an organic light-emitting diode (OLED) display panel, a microLED display panel, or a mini-LED display panel. In this case, the display unit 201 may include a pixel circuit P and a light-emitting element D. The pixel circuit P may be electrically connected to the light-emitting element D to drive the light-emitting element D to emit light. The pixel circuit P may include a typical 7T1C pixel circuit, that is, the pixel circuit may include a driving transistor M1, a reset transistor M2, a data writing transistor M3, a threshold compensation transistor M4, an initialization transistor M5, a first light-emitting control transistor M6, a second light-emitting control transistor M7, and a storage capacitor Cst. The reset transistor M2 can be controlled to turn on in the reset stage by a first gate signal SN1 so that a reset signal Vref1 can reset a gate of the driving transistor M1. The data writing transistor M3 can be controlled to turn on at least in the data writing stage by a second gate signal SP, and the threshold compensation transistor M4 can be controlled to turn on at least in the threshold compensation stage by a third gate signal SN2 so that a data signal Vdata can be written to the gate of the driving transistor M1, a threshold voltage of the driving transistor M1 can be written to the gate of the driving transistor M1, and the data signal Vdata and the threshold voltage of the driving transistor M1 can be stored in the storage capacitor Cst. The initialization transistor M6 can be controlled to turn on at least in the initialization stage by a fourth gate signal SP* so that an initialization signal Vref2 can be transmitted to an anode of the light-emitting element D to initialize the anode of the light-emitting element D. The first light-emitting control transistor M6 and the second light-emitting control transistor M7 can be controlled to turn on at least in the light-emitting stage by a light-emitting control signal EM. In this case, a conductive path is formed between a positive power signal PVDD and a negative power signal PVEE so that the driving transistor M1 can generate a driving current according to a signal at the gate of the driving transistor M1 and supply the driving current to the light-emitting element D to drive the light-emitting element D to emit light.

It should be noted that the preceding description is only an exemplary illustration using the pixel circuit P including the typical 7T1C pixel circuit as an example, and in the embodiments of the present disclosure, the pixel circuit may also include a pixel circuit in other forms, such as an 8T1C pixel circuit (including eight transistors and one storage capacitor) or a 14T2C pixel circuit (including 14 transistors and two capacitors), which may be specifically designed according to actual requirements and is not specifically limited in the embodiments of the present disclosure under the premise that the core invention of the embodiments of the present disclosure can be achieved.

With continued reference to FIG. 3, the light-emitting element D may include an OLED, a microLED, or a mini-LED, which may be specifically designed according to actual requirements and is also not specifically limited in the embodiments of the present disclosure. Using the light-emitting element D including the OLED as an example, the light-emitting element D may include the anode, a cathode, and a light-emitting layer located between the anode and the cathode, where the first display electrode may be one of the anode of the light-emitting element D or the cathode of the light-emitting element D.

In an embodiment, referring to FIGS. 1 and 4, the display function layer 20 may include a driving circuit layer 20P and a light-emitting function layer 20D located on one side of the driving circuit layer 20P facing away from the base substrate 10. The driving circuit layer 20P includes multiple pixel circuits P arranged in an array, and the light-emitting function layer 20D includes multiple light-emitting elements D. The light-emitting element D includes the first display electrode 21, a second display electrode 22, and a light-emitting layer 23 located between the first display electrode 21 and the second display electrode 22. The multiple pixel circuits P are electrically connected to second display electrodes 22 respectively. The multiple pixel circuits P and the multiple light-emitting elements D that are connected respectively form the multiple display units 201.

It is to be understood that FIG. 4 only exemplarily represents the pixel circuit P with the structure of one transistor, and the structure of the pixel circuit P is not limited to this, that is, the pixel circuit P may further include other active and/or passive devices; the active devices may include three-terminal or four-terminal devices such as transistors, and the passive devices may include two-terminal devices such as capacitors, resistors, and inductors. The structure of the pixel circuit P may be designed according to actual requirements and is not specifically limited in the embodiments of the present disclosure.

The driving circuit layer 20P includes the multiple pixel circuits P arranged in an array, and each device in the pixel circuit P is formed by a respective conductive structure so that the driving circuit layer 20P can include a semiconductor layer 24, a first conductive layer 25, a second conductive layer 26, an insulating layer 210 located between the semiconductor layer 24 and the first conductive layer 25, an insulating layer 220 located between the first conductive layer 25 and the second conductive layer 26, a planarization layer 230 covering the second conductive layer 26, and others. The semiconductor layer 24 may include active layers of the transistors and others, the first conductive layer 25 may include gates of the transistors and/or a plate of the capacitor, and others, and the second conductive layer 26 may include signal lines connected to the transistors and others. The conductive layers with insulating spacers are arranged in the driving circuit layer 20P, and the conductive layers are patterned to form conductive structures so that the conductive structures between the conductive layers are interconnected to form the pixel circuits P.

The light-emitting function layer 20D includes the multiple light-emitting elements D. One of the first display electrode 21 of the light-emitting element D or the second display electrode 22 of the light-emitting element D may be the anode of the light-emitting element D, and the other one of the first display electrode 21 of the light-emitting element D or the second display electrode 22 of the light-emitting element D may be the cathode of the light-emitting element D. For example, the first display electrode 21 may be the cathode of the light-emitting element D, and the second display electrode 22 may be the anode of the light-emitting element D, that is, an electrode on one side of the light-emitting element D that is farther away from the base substrate 10 may be the first display electrode 21. Since the pixel circuit P is electrically connected to the second display electrode 22 of the light-emitting element D, the pixel circuit P can supply a driving current signal to the second display electrode 22 of the light-emitting element D, and the first display electrode 21 of the light-emitting element D can receive a power signal. Under the joint action of the driving signal supplied by the pixel circuit P and the power signal, photons of the light-emitting layer 23 of the light-emitting element D can be excited so that the light-emitting element D can display light emission.

In addition, the touch display panel 100 may further include an encapsulation layer 250 covering the display function layer 20. The encapsulation layer 250 can protect the light-emitting elements D and the pixel circuits P in the display function layer 20 to a certain extent.

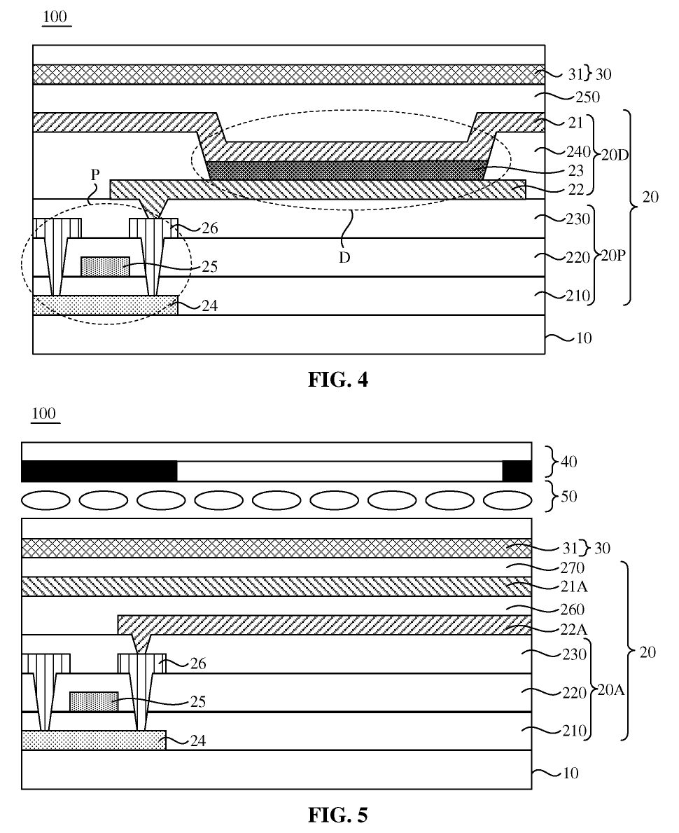

In other embodiments, as shown in FIG. 5, the touch display panel 100 may also be the non-self-luminous display panel. For example, when being a liquid-crystal display panel, the touch display panel 100 may include an array substrate, an opposing substrate 40, and a liquid crystal layer 50 located between the array substrate and the opposing substrate 40. The array substrate may include a base substrate 10, a driving circuit layer 20A a second display electrode layer 22A, a first display electrode layer 21A that are located on one side of the base substrate, an insulating layer 260 located between the second display electrode layer 21A and the first display electrode layer 22A, an insulating layer 270 covering the first display electrode layer 21A, and others. The driving circuit layer 20A may include multiple driving circuits arranged in an array, and a driving circuit of the multiple driving circuits may be formed by active devices and/or passive devices. For example, the driving circuit may include transistors. The driving circuit layer 20A may include a semiconductor layer 24, a first conductive layer 25, a second conductive layer 26, an insulating layer 210 located between the semiconductor layer 24 and the first conductive layer 25, an insulating layer 220 located between the first conductive layer 25 and the second conductive layer 26, a planarization layer 230 covering the second conductive layer 26, and others. The semiconductor layer 24 may include active layers of transistors, the first conductive layer 25 may include gates of the transistors, and the second conductive layer 26 may include signal lines connected to the transistors. The first display electrode layer 21A may include common electrodes, and the second display electrode layer 22A may include pixel electrodes. The pixel electrodes may be electrically connected to the driving circuits so that the driving circuits can supply driving signals to the pixel electrodes, and the common electrodes can receive common voltage signals so that voltages can be generated between the pixel electrodes and the common electrodes to drive liquid-crystal molecules in the liquid-crystal layer 50 to twist, thereby enabling light to pass through the liquid-crystal layer 50 to reach the opposing substrate 40 and further enabling the touch display panel 100 to display light emission.

When the touch display panel 100 is the liquid-crystal display panel, the display unit 201 may include a driving circuit, a pixel electrode, a common electrode, a liquid-crystal layer, a color resist structure arranged in the opposing substrate 40, and others. In this case, one of the pixel electrode or the common electrode may be the first display electrode 21 of the display unit 201, and the other one of the pixel electrode or the common electrode may be the second display electrode 22. In an exemplary embodiment, an electrode on one side of the display unit 201 that is farther away from the base substrate 10 may be used as the first display electrode 21. For example, a common electrode arranged in the common layer 21A may be the first display electrode 21.

It should be noted that the preceding is only an exemplary description of the structure of the display function layer of the touch display panel provided in the embodiments of the present disclosure, and the structure of the touch display panel in the embodiments of the present disclosure is not limited thereto and may be designed according to actual requirements. For ease of description, unless otherwise specified, the technical solutions in the embodiments of the present disclosure are illustrated using an example in which the display unit of the touch display panel includes the pixel circuit and the light-emitting element in the embodiments of the present disclosure.

With continued reference to FIGS. 1 and 2, the touch display panel 100 may further include a touch function layer 30 located on the side of the base substrate 10. The touch function layer 30 includes multiple touch units 301, and a touch unit 301 of the multiple touch units 301 includes a first touch electrode 31. In this case, the operation process of the touch display panel 100 at least includes a touch stage, and in the touch stage, first touch electrodes 31 of the touch units 301 receive a second touch signal VTX2.

It is to be understood that the touch unit 301 may be a self-capacitive touch unit or a mutual-capacitive touch unit, which may be specifically designed according to actual requirements and is not specifically limited in the embodiments of the present disclosure.

In an embodiment, when the touch unit 301 is the self-capacitive touch unit, a touch capacitor can be formed between the first touch electrode 31 and the ground so that in the touch stage, the second touch signal VTX2 can be supplied to the first touch electrode 31, and a touch sensing signal VRX fed back by the first touch electrode 31 can be received. Through the second touch signal VTX2 and the touch sensing signal VRX, the capacitor size or the amount of capacitor change that is formed between the first touch electrode 31 and the ground can be determined, and according to the capacitor size or the amount of capacitor change, a touch position of a touch object such as a finger can be determined to enable touch detection.

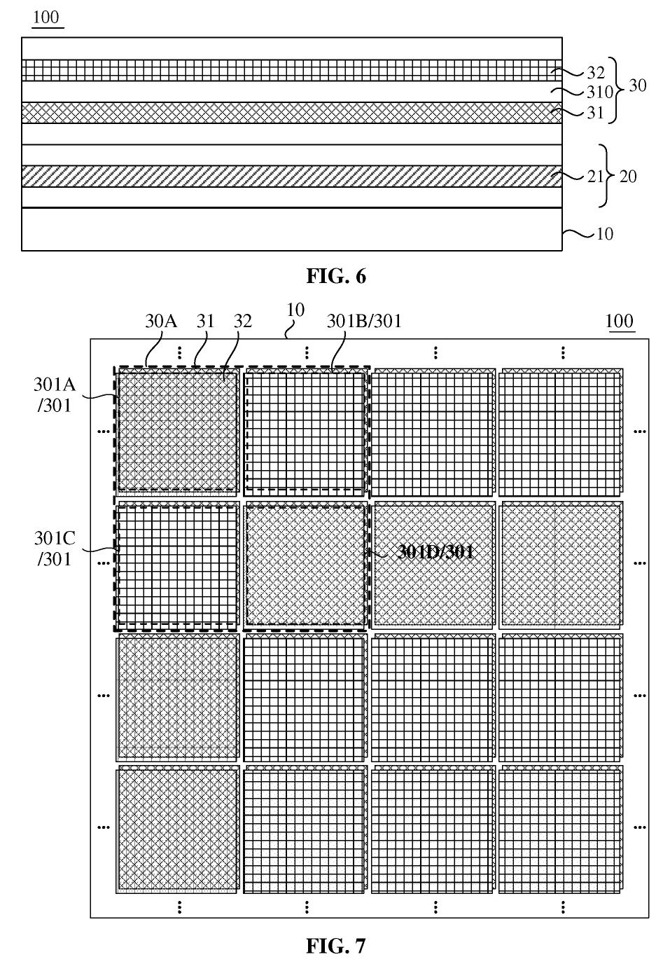

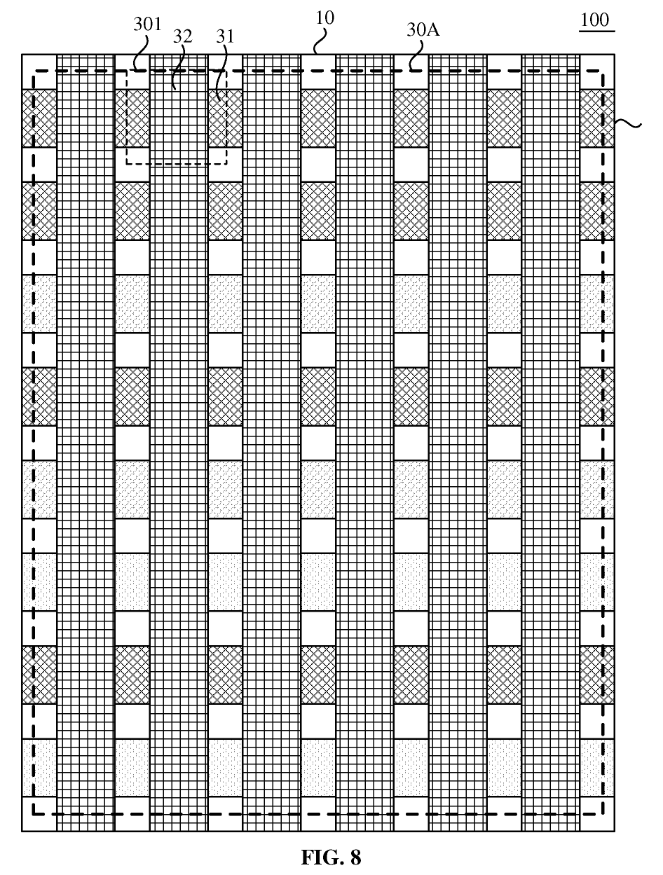

In another embodiment, referring to FIGS. 6 to 10, the touch unit 301 may also be the mutual-capacitive touch unit. In this case, the touch unit 301 may include the first touch electrode 31 and a second touch electrode 32. In the touch stage, the first touch electrodes 31 of the touch units 301 receive the first touch signal, and second touch electrodes 32 of the touch units 301 output touch sensing signals in sequence.

It is to be understood that the first touch electrode 31 and the second touch electrode 32 may be located in the same film or in different films, which may be specifically designed according to actual requirements and is not specifically limited in the embodiments of the present disclosure.

In a feasible embodiment, referring to FIGS. 6 to 8, the touch function layer 30 may include a first touch electrode layer, a second touch electrode layer, and an insulating layer 310 located between the first touch electrode layer and the second touch electrode layer. The first touch electrode layer may include the first touch electrodes 31, and the second touch electrode layer may include the second touch electrodes 32. The first touch electrode 31 and the second touch electrode 32 may be block-shaped or strip-shaped structures. In a direction perpendicular to the plane on which the base substrate 10 is located, the first touch electrode 31 and the second touch electrode 32 overlap to form a capacitor of the touch unit 301. In the touch stage, the second touch signal is supplied to the first touch electrode 31 so that the capacitor formed by the first touch electrode 31 and the second touch electrode 32 can be charged, and the capacitor size between the first touch electrode 31 and the second touch electrode 32 can be determined by receiving the touch sensing signal output by the second touch electrode 32 so that a touch position of a touch object such as a finger on the touch surface of the touch display panel 100 can be determined, thereby enabling touch detection.

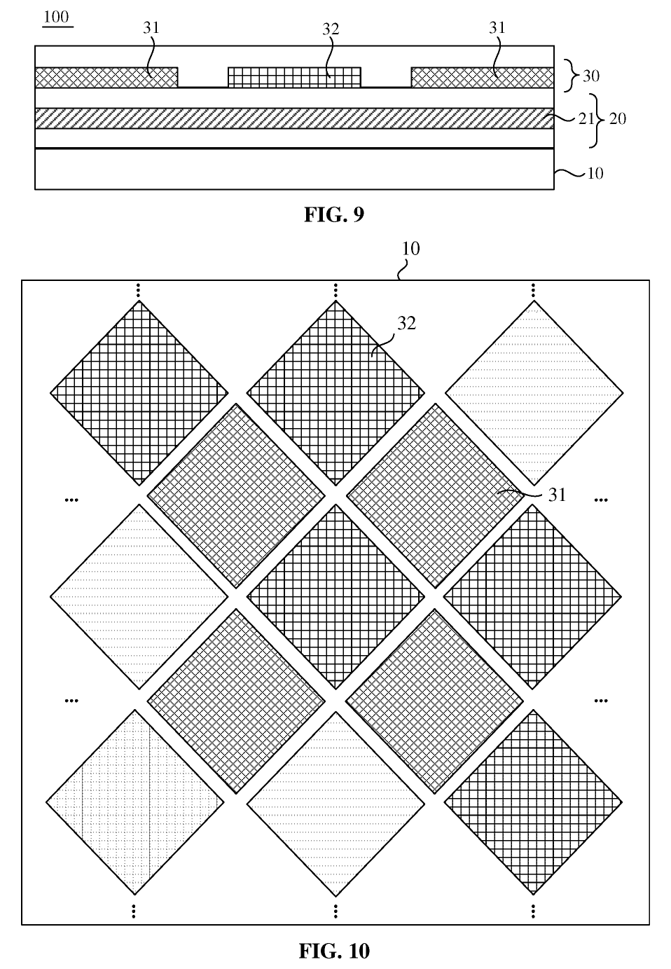

In other feasible embodiments, referring to FIGS. 9 and 10, the first touch electrode 31 and the second touch electrode 32 may also be arranged in the same layer. In this case, the touch function layer 30 may include only one touch electrode layer, the touch electrode layer includes the first touch electrodes 31 and the second touch electrodes 32, and the first touch electrodes 31 and the second touch electrodes 32 are alternately arranged in the touch electrode layer so that capacitors can be formed between the second touch electrode 32 and first touch electrodes 31 around the second touch electrode 32. The capacitors formed by the first touch electrodes 31 and the second touch electrode 32 are charged, and the capacitor sizes between the first touch electrodes 31 and the second touch electrode 32 are detected so that touch detection can also be enabled.

It should be noted that the preceding is only an exemplary description of the structure of the touch unit 301, and the structure of the touch unit in the embodiments of the present disclosure is not limited thereto, which may be designed according to actual requirements and is not specifically limited in the embodiments of the present disclosure. For ease of description, unless otherwise specified, the technical solutions in the embodiments of the present disclosure are illustrated using an example in which the touch unit includes the first touch electrode and the second touch electrode that are located in different films, and the first touch electrode and the second touch electrode are strip-shaped structures in the embodiments of the present disclosure.

It is to be understood that the touch function layer 30 may be located on one side of the display function layer 20 facing away from the base substrate, and since the first display electrode 21 in the display function layer 20 is an electrode farthest from the base substrate 10, the first touch electrode 31 and/or the second touch electrode 32 in the touch function layer 30 are relatively close to the first display electrode 21 in the display function layer 20. In this manner, in the direction perpendicular to the plane on which the base substrate 10 is located, when the first touch electrode 31 and/or the second touch electrode 32 overlap the first display electrode 21, a coupling capacitor is formed in a position in which the first touch electrode 31 and/or the second touch electrode 32 overlap the first display electrode 21.

In the related art, in the touch stage, the first display electrode receives a corresponding display signal, and the display signal is typically a direct current signal different from a touch signal. Due to the coupling effect of the coupling capacitor formed by the first touch electrode and/or the second touch electrode and the first display electrode, the display signal of the first display electrode is coupled to the first touch electrode and/or the second touch electrode, thereby affecting the accuracy of the signal on the first touch electrode and/or the second touch electrode, generating touch noise, and further affecting the touch accuracy. Moreover, since the touch signal received by the first touch electrode is typically a square wave signal, and the square wave signal is also coupled to the first display electrode, the signal on the first display electrode changes with the square wave signal, thereby generating a display water ripple and affecting the display effect of the touch display panel.

In the embodiments of the present disclosure, referring to FIGS. 1, 6, 8, and 11 , in the touch stage Tt, the first touch electrodes 31 of the touch units 301 receive the second touch signal VTX2, while the first display electrodes 21 of the display units 201 receive a first touch signal VTX1; the first touch signal VTX1 and the second touch signal VTX2 each include an alternating current signal.

In the touch stage Tt, the first touch signal VTX1 and the second touch signal VTX2 each including the alternating current signal may be understood that the amplitude of the first touch signal VTX1 and the amplitude of the second touch signal VTX2 may change in a certain period, and the amplitude change period of the first touch signal VTX1 and the amplitude change period of the second touch signal VTX2 may be the same or different, which may be designed according to actual requirements. Using the amplitude change period of the first touch signal VTX1 being the same as the amplitude change period of the second touch signal VTX2 as an example, the amplitude change period of the first touch signal VTX1 and the amplitude change period of the second touch signal VTX2 may be H. In the amplitude change period, the first touch signal VTX1 may include a first amplitude V11 and a second amplitude V12, the second touch signal VTX2 may include a third amplitude V21 and a fourth amplitude V22, the absolute value of the first amplitude V11 may be greater than the absolute value of the second amplitude V12, and the absolute value of the third amplitude V21 may be greater than the absolute value of the fourth amplitude V22. It is to be understood that the absolute value of the first amplitude V11 and the absolute value of the third amplitude V21 may be the same or different, and the absolute value of the second amplitude V12 and the absolute value of the fourth amplitude V22 may be the same or different, which may be specifically designed according to actual requirements and are not specifically limited in the embodiments of the present disclosure.

Specifically, in the touch stage, the first display electrode 21 receives the alternating current first touch signal VTX1, and the alternating current first touch signal VTX1 can be coupled to the first touch electrode 31 and/or the second touch electrode 32 through the coupling capacitor formed by the first display electrode 21, the first touch electrode 31, and/or the second touch electrode 32 so that the signal coupled to the first touch electrode 31 and /or the second touch electrode 32 can be an alternating current signal consistent with the second touch signal VTX2, thereby reducing the impact of the signal of the first display electrode 21 on the signal on the first touch electrode 31 and /or the second touch electrode 32, further reducing the touch noise, and improving the sensitivity and accuracy of touch detection. When the first touch signal VTX1 received by the first display electrode 21 is an alternating current signal, a signal that is inverted relative to the first touch signal VTX1 can be supplied to the second display electrode 22 of the display unit 201 so that the signals of the first display electrode 21 and the second display electrode 22 in the display unit 201 can be mutually canceled, thereby ensuring the display light-emitting effect of the display unit 201. Alternatively, the first touch signal VTX1 received by the first display electrode 21 may be an alternating current signal with a small amplitude change, for example, there is a small difference between the first amplitude V11 of the first touch signal VTX1 and the second amplitude V12 of the first touch signal VTX1, so that the impact of the first touch signal VTX1 on the display light-emitting effect of the display unit 201 can be ignored, thereby ensuring the display light-emitting effect of the display unit 201.

In this embodiment, in the touch stage of the touch display panel, the first display electrodes of the display units are controlled to receive the alternating current first touch signal, and the first touch electrodes of the touch units are controlled to receive the alternating current second touch signal, that is, the first display electrodes and the first touch electrodes receive the alternating current signals in the touch stage, so that the signal type on the first display electrodes can remain consistent with the signal type on the first touch electrodes, and the signals coupled from the first display electrodes to the first touch electrodes can remain consistent with the signals coupled from the first touch electrodes to the first display electrodes, so as to ameliorate the case where the difference in the signal types received by the first display electrodes and the first touch electrodes in the touch stage causes the signals of the first display electrodes to affect the signals of the first touch electrodes and causes the signals of the first touch electrodes to affect the signals of the first display electrodes, thereby improving the touch sensitivity of the touch display panel and the display effect of the touch display panel.

On the basis of the preceding embodiment, referring to FIGS. 1, 8, and 11, the operation process of the touch display panel 100 further includes a display stage Td; in the display stage Td, the first display electrodes 21 of the display units 201 receive a first power signal V10; the first power signal V10 is a direct current signal.

In the case where the touch display panel 100 is the self-luminous display panel, the display stage of the touch display panel 100 may be understood as a duration during which the pixel circuit in the display unit 201 operates normally and drives the light-emitting element to display light emission. The display duration of one frame of image of the touch display panel 100 may include one or more display stages. When the display duration of one frame of image of the touch display panel 100 includes multiple display stages, each display stage can control pixel circuits in multiple rows of display units 201 to drive light-emitting elements in the multiple rows of display units 201 to display light emission. The touch stage Tt may be located between two adjacent display stages. In this case, the touch stage Tt may be located within the display duration of one frame of image and/or between the display durations of two adjacent frames of image, which may be specifically designed according to actual requirements and is not specifically limited in the embodiments of the present disclosure.

Specifically, the first display electrode 21 may be the cathode of the light-emitting element or the anode of the light-emitting element. In this case, the first power signal V10 may be a negative power signal or a positive power signal. The first display electrode 21 is enabled to receive the direct current first power signal V10 so that the light-emitting element can emit light stably in the display stage. This prevents an alternating signal from being supplied to the first display electrode 21, which could otherwise cause fluctuations in light emission of the signal on the first display electrode 21 and result in a display water ripple. Consequently, the display effect of the touch display panel can be improved.

It is to be understood that when being the positive power signal, the first power signal V10 can be a high-level signal greater than 0 V such that the first power signal V10 can be a power signal with a positive polarity. When being the negative power signal, the first power signal V10 can be a low-level signal less than or equal to 0 V such that the first power signal V10 can be a power signal with a negative polarity. The specific polarity selection of the first power signal V10 may be designed according to actual requirements, which is not specifically limited in the embodiments of the present disclosure. For ease of description, unless otherwise specified, the technical solutions in the embodiments of the present disclosure are illustrated using an example in which the first display electrode 21 is the cathode of the light-emitting element, and the first power signal V10 is the power signal with a negative polarity in the embodiments of the present disclosure.

In addition, it is to be understood that the polarity of the first power signal received by the first display electrode in the display stage and the polarity of the first touch signal received by the first display electrode in the touch stage may be the same or different, which may be specifically designed according to actual requirements and is not specifically limited in the embodiments of the present disclosure.

In an embodiment, as shown in FIG. 12 or 13, the first power signal V10 has the same polarity as the first touch signal. In this case, if the first power signal V10 may be the power signal with a negative polarity, that is, the first power signal V10 is less than or equal to 0, the first touch signal VTX1 is also the power signal with a negative polarity; the first amplitude V11 of the first touch signal VTX1 and the second amplitude V12 of the first touch signal VTX1 may both be less than or equal to 0; or the first amplitude V11 may be greater than 0, and the second amplitude V12 may be less than or equal to 0. In this manner, in the transition from the display stage Td to the touch stage Tt, the signal supplied to the first display electrode does not have a large hopping amount, thereby avoiding the case where a large instantaneous fluctuation in the signal on the first display electrode-caused by large hopping of the signal supplied to the first display electrode-affects the display light-emitting brightness of the display unit, thereby improving the display light-emitting accuracy of the display unit and further improving the display effect of the touch display panel. In addition, the polarity of the first power signal V10 received by the first display electrode in the display stage is enabled to be the same as the polarity of the first touch signal VTX1 received by the first display electrode in the touch stage so that power consumption waste caused by charging or discharging the first display electrode due to signal hopping can be avoided, thereby reducing the overall power consumption of the touch display panel.

On the basis of the preceding embodiments, when the polarity of the first power signal V10 received by the first display electrode in the display stage is the same as the polarity of the first touch signal VTX1 received by the first display electrode in the touch stage, and the first touch signal VTX1 is a square wave signal, the first amplitude V11 or the second amplitude V12 of the first touch signal VTX1 can be the same as the amplitude of the first power signal V10, so as to ensure that the signal received by the first display electrode in the touch stage can also ensure that the light-emitting element accurately displays light emission.

It should be noted that the preceding is only an exemplary description of the polarity of the first power signal received by the first display electrode in the display stage and the polarity of the first touch signal received by the first display electrode in the touch stage. In the embodiments of the present disclosure, the polarity of a signal received by the first touch electrode in the display stage and the polarity of the second touch signal received by the first touch electrode in the touch stage may also be the same or different, which may be specifically designed according to actual requirements and is not specifically limited in the embodiments of the present disclosure.

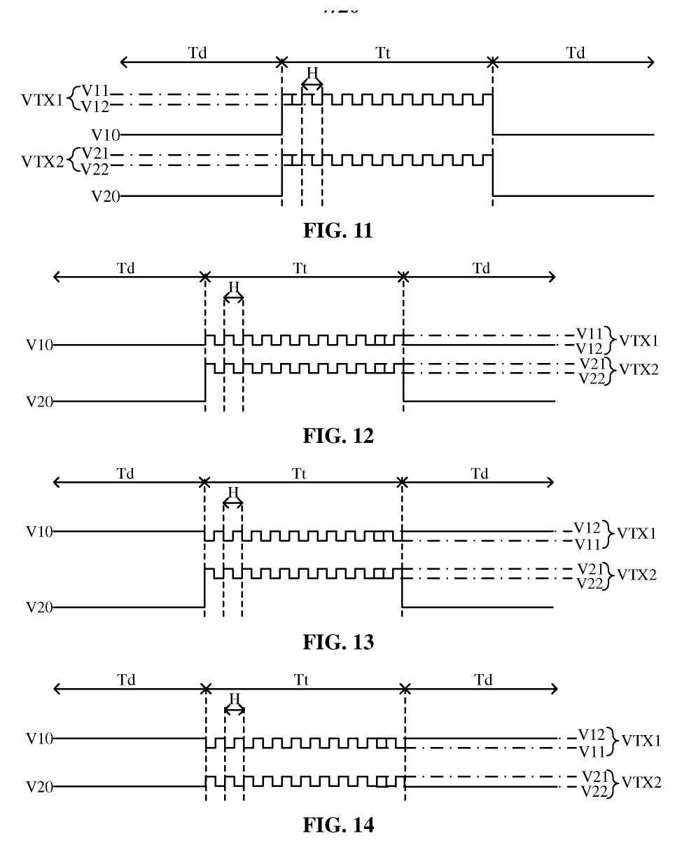

In an embodiment, referring to FIGS. 11 to 13, the first touch electrode may receive a second power signal V20 or may be in a suspended state in the display stage Td.

When the first touch electrode receives the second power signal V20 in the display stage Td, the second power signal V20 may be a direct current signal so that the signal on the first display electrode can be prevented from being affected due to a fluctuation in the signal received by the first display electrode, thereby improving the display accuracy of the display unit.

As a feasible embodiment, with continued reference to FIGS. 11 to 13, the second power signal V20 received by the first touch electrode in the display stage Td and the second touch signal VTX2 received by the first touch electrode in the touch stage Tt can have opposite polarities, thereby ensuring that the touch signal received by the first touch electrode hops, and through the coupling effect of the capacitor in the touch unit, the coupling amount of the signal of the second touch electrode that is coupled to the touch unit can be large, thereby accurately and quickly charging the capacitor of the touch unit.

In other feasible embodiments, as shown in FIG. 14, the second power signal V20 received by the first touch electrode in the display stage Td can also have the same polarity as the second touch signal VTX2 received by the first touch electrode in the touch stage Tt, thereby reducing the power consumption caused by signal hopping and the overall power consumption of the touch display panel.

For ease of description, unless otherwise specified, the technical solutions in the embodiments of the present disclosure are illustrated using an example in which the signal received by the first touch electrode in the display stage and the second touch signal received by the first touch electrode in the touch stage have the opposite polarities in the embodiments of the present disclosure.

It should be noted that the preceding is only an exemplary description of the polarities of the signals received by the first display electrode in the display stage and the touch stage and the polarities of the signals received by the first touch electrode in the display stage and the touch stage. In the embodiments of the present disclosure, the polarity of the signal received by the first touch electrode in the display stage and the polarity of the signal received by the first display electrode in the display stage may be the same or different, and the polarity of the signal received by the first touch electrode in the touch stage and the polarity of the signal received by the first display electrode in the touch stage may be the same or different, which may be specifically designed according to actual requirements and are not specifically limited in the embodiments of the present disclosure.

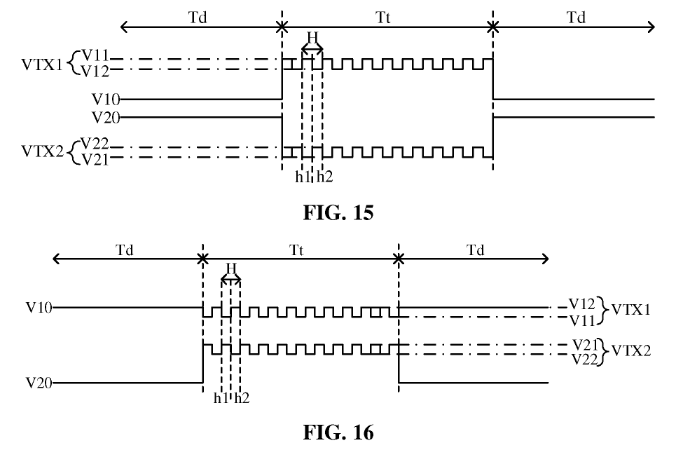

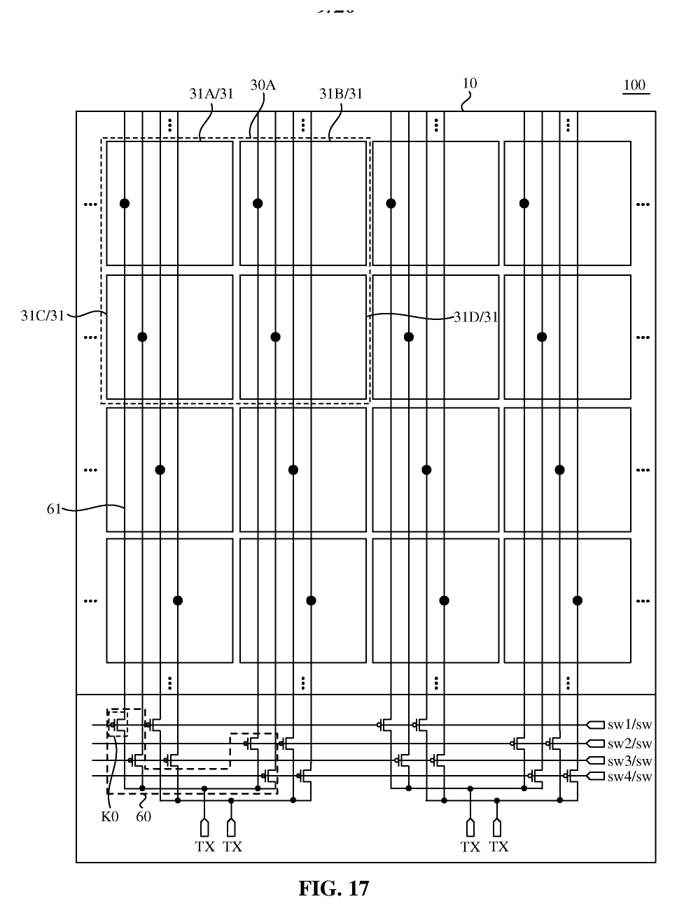

In an embodiment, referring to FIG. 15 or FIG. 17,the first touch signal VTX1 and the second touch signal VTX2 have opposite polarities.

When the first touch signal VTX1 has a negative polarity, the second touch signal VTX2 may have a positive polarity, or when the first touch signal VTX1 has a positive polarity, the second touch signal VTX2 may have a negative polarity, which may be specifically designed according to actual requirements and is not specifically limited in the embodiments of the present disclosure.

Specifically, when the first touch signal VTX1 has a negative polarity, and the second touch signal VTX2 has a positive polarity, the amplitude of the first touch signal VTX1 may be less than or equal to 0, and the amplitude of the second touch signal VTX2 may be greater than 0 so that in the touch stage, the first touch signal VTX1 with an amplitude less than or equal to 0 received by the first display electrode can be coupled to the first touch electrode and/or the second touch electrode, and the second touch signal VTX2 with an amplitude greater than 0 received by the first touch electrode can also be coupled to the first display electrode. In this case, at least part of the coupled signals of the first touch signal VTX1 and the second touch signal VTX2 can be canceled, thereby reducing the impact of the first touch signal VTX1 on the signal on the first touch electrode and/or the second touch electrode and the impact of the second touch signal VTX2 on the signal on the first display electrode and further improving the sensitivity and accuracy of touch detection of the touch unit and the display light-emitting accuracy of the display unit.

On the basis of the preceding embodiment, with continued reference to FIGS. 15 and 16, at the same moment in the touch stage, the amplitude of the first touch signal is V1, and the amplitude of the second touch signal is V2; where V1 = − V2.

Specifically, when the first touch signal and the second touch signal are both square wave signals, the first touch signal VTX1 may include the first amplitude V11 and the second amplitude V12, and the second touch signal VTX2 may include the third amplitude V21 and the fourth amplitude V22. In this case, one signal period H may include a first duration h1 and a second duration h2. In the first duration h1, the amplitude V1 of the first touch signal VTX1 may be the first amplitude V11, and the amplitude V2 of the second touch signal VTX2 may be the third amplitude V21; in the second duration h2, the amplitude V1 of the first touch signal VTX1 may be the second amplitude V12, and the amplitude V2 of the second touch signal VTX2 may be the fourth amplitude V22. V11 = − V21, and V12 = − V22. In this manner, in the touch stage, the first touch signal VTX1 and the second touch signal VTX2 have the same absolute value of amplitude but opposite polarities so that the coupling amount of the first touch signal VTX1 and the coupling amount of the second touch signal VTX2 can be mutually canceled, thereby preventing the first touch signal VTX1 from affecting the touch detection of the touch unit and the second touch signal VTX2 from affecting the display light-emitting brightness of the display unit and further ensuring that the touch unit has high touch sensitivity and accuracy and that the display unit has accurate display light-emitting brightness.

With continued reference to FIGS. 15 and 16, in the display stage Td, the polarity of the first power signal V10 received by the first display electrode and the polarity of the second power signal V20 received by the first touch electrode may be the same or different. When the first power signal V10 and the second power signal V20 have different polarities, this can also ensure that in the display stage Td, the coupling amount of the first power signal V10 and the coupling amount of the second power signal V20 can be mutually canceled, thereby improving the display light-emitting accuracy while ensuring the touch sensitivity and accuracy.

It should be noted that the preceding is only an exemplary description of the polarities of the signals received by the first display electrode and the second touch electrode in the display stage and the polarities of the signals received by the first display electrode and the second touch electrode in the touch stage. Under the premise that the core invention of the embodiments of the present disclosure can be achieved, the polarities of the signals received by the first display electrode and the second touch electrode in the display stage and the polarities of the signals received by the first display electrode and the second touch electrode in the touch stage are not limited to the preceding combinations, which may be designed according to actual requirements. For ease of description, unless otherwise specified, the technical solutions in the embodiments of the present disclosure are illustrated using the case shown in FIG. 16 as an example in the embodiments of the present disclosure.

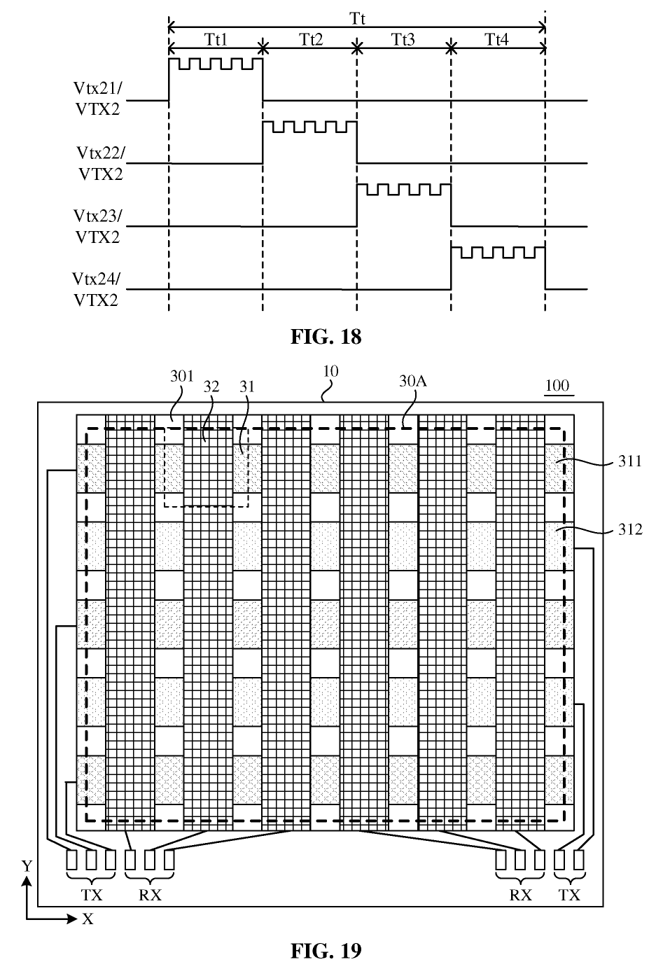

On the basis of the preceding embodiments, referring to FIGS. 17 and 18, the touch function layer includes the first touch electrode layer, and the first touch electrode layer includes the multiple first touch electrodes 31; the multiple first touch electrodes 31 form at least one first touch electrode group 30A; in the touch stage Tt, first touch electrode 31 in the same touch electrode group 30A receives the second touch signal VTX2 in a time-division manner.

The multiple first touch electrodes 31 may form one or more first touch electrode groups 30A. Each first touch electrode group 30A may include N first touch electrodes 31, and N may be a positive integer. In this case, the touch stage Tt may include N touch sub-stages.

Exemplarily, as shown in FIGS. 17 and 18, the first touch electrode group 30A may include four first touch electrodes 31 (31A, 31B, 31C, and 31D), and the touch stage Tt may correspondingly include four touch sub-stages (Tt1, Tt2, Tt3, and Tt4). In the first touch sub-stage Tt1, a second touch signal Vtx21 may be supplied to first touch electrodes 31A of the first touch electrode groups 30A. In the second touch sub-stage Tt2, a second touch signal Vtx22 may be supplied to first touch electrodes 31B of the first touch electrode groups 30A. In the third touch sub-stage Tt3, a second touch signal Vtx23 may be supplied to first touch electrodes 31C of the first touch electrode groups 30A. In the fourth touch sub-stage Tt4, a second touch signal Vtx24 may be supplied to first touch electrodes 31D of the first touch electrode groups 30A. In this manner, the second touch signal VTX2 may be supplied to the first touch electrodes 31 of the same first touch electrode group 30A in a time-division manner.

When the second touch signal VTX2 is supplied to the first touch electrodes 31 of the same first touch electrode group 30A in a time-division manner, the first touch electrodes 31 of the same first touch electrode group 30A may be electrically connected to the same first touch signal terminal TX. In this case, the touch display panel may further be provided with multi-channel selection circuits 60. Each multi-channel selection circuit 60 may include N selection switches K0. For example, when N is equal to 4, the multi-channel selection circuit 60 may include four selection switches K0. Control terminals of the selection switches K0 receive different switch selection signals sw (sw1, sw2, sw3, and sw4) respectively, and first terminals of the selection switches K0 are electrically connected to the first touch electrodes 31 through touch wires 61 respectively. Selection switches K0 electrically connected to the first touch electrodes 31 of the same first touch electrode group 30A belong to the same multi-channel selection circuit 60. Second terminals of the selection switches K0 of the same multi-channel selection circuit are electrically connected to the same first touch terminal TX. In this manner, the selection switches K0 of the same multi-channel selection circuit are controlled to turn on in a time-division manner so that the second touch signal VTX2 can be supplied to the first touch electrodes 31 of the same first touch electrode group 30A in a time-division manner. Moreover, since the same first touch electrode group 30A is electrically connected to the same first touch terminal TX through the multi-channel selection circuit 60, the number of first touch terminals TX provided in the touch display panel 100 can be reduced, thereby reducing the number of terminals for providing the second touch signal VTX2 in a driver chip and the cost of the driver chip.

It should be noted that the preceding is only an exemplary description of the first touch electrode group including the four first touch electrodes, and in the embodiments of the present disclosure, the number of first touch electrodes in the first touch electrode group may also be 1, 2, 3, or any integer greater than 3, which may be designed according to actual requirements and is not specifically limited in the embodiments of the present disclosure.

It should also be noted that the preceding is only an exemplary description of the first touch electrode being a block-shaped electrode, but in the embodiments of the present disclosure, the first touch electrode may also be a strip-shaped electrode so that first touch electrodes of touch units located in the same row form an integrated structure, or the first touch electrode may also be a planar touch electrode so that first touch electrodes of the touch units form an integrated structure. The specific shape of the first touch electrode may be designed according to actual requirements and is not specifically limited in the embodiments of the present disclosure.

Exemplarily, as shown in FIG. 19, when the first touch electrode 31 is the strip-shaped electrode, the first touch electrodes 31 are arranged along the Y direction in sequence. In this case, the second touch electrode 32 is also a strip-shaped electrode, and the second touch electrodes 32 are arranged along the X direction in sequence. The first touch electrodes 31 are electrically connected to touch terminals TX through corresponding signal lines respectively, and the second touch electrodes 32 are electrically connected to sensing terminals RX through corresponding signal lines respectively. In this manner, after the second touch signal VTX2 is supplied to a first touch electrode 311, touch sensing signals fed back by the second touch electrodes 32 can be received through the sensing terminals RX respectively to determine whether the touch position overlaps the first touch electrode 311; the second touch signal VTX2 is then supplied to a first touch electrode 312, and touch sensing signals fed back by the second touch electrodes 32 are received again through the sensing terminals RX respectively to determine whether the touch position overlaps the first touch electrode 312. In this manner, the touch position can be detected by supplying the second touch signal VTX2 to the first touch electrodes 31 in a time-division manner.

For ease of description, unless otherwise specified, the technical solutions in the embodiments of the present disclosure are illustrated using an example in which the first touch electrode is the strip-shaped electrode in the embodiments of the present disclosure.

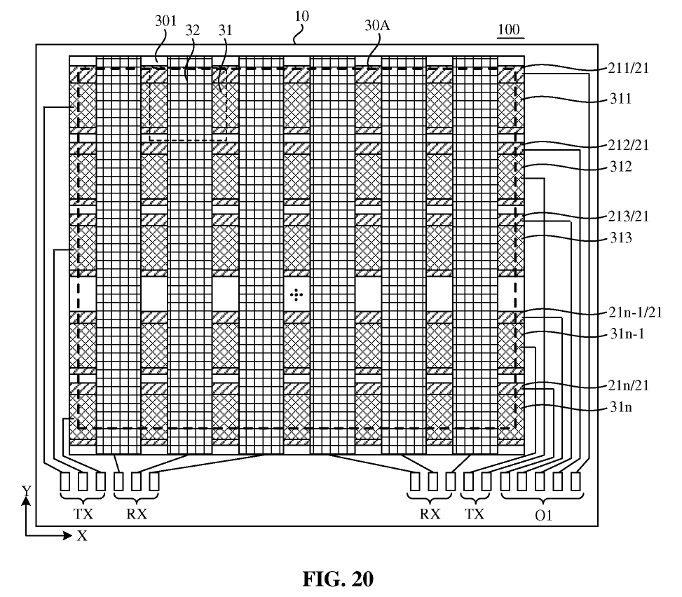

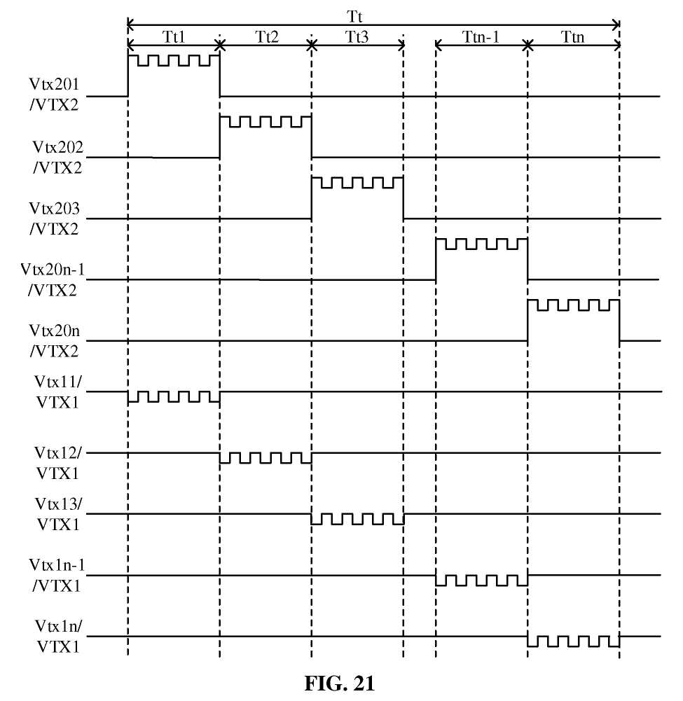

On the basis of the preceding embodiments, referring to FIGS. 20 and 21, the display function layer includes the first display electrode layer; the first display electrode layer includes the multiple first display electrodes 21 respectively corresponding to the multiple first touch electrodes 31; in the direction perpendicular to the plane on which the base substrate 10 is located, a first touch electrode 31 overlaps a first display electrode 21 corresponding to the first touch electrode 31; the overlapping first touch electrode 31 and first display electrode 21 form one overlapping electrode group; in the touch stage Tt, in the same overlapping electrode group, the duration for the first touch electrode 31 to receive the second touch signal VTX2 overlaps the duration for the first display electrode 21 to receive the first touch signal VTX1.

The number of first display electrodes 21 in the first display electrode layer may be the same as or different from the number of first touch electrodes 31 in the first touch electrode layer, which may be specifically designed according to time requirements and is not specifically limited in the embodiments of the present disclosure.

Exemplarily, the number of first display electrodes 21 in the first display electrode layer being the same as the number of first touch electrodes 31 in the first touch electrode layer is used as an example, that is, when the first touch electrode layer includes n first touch electrodes 31, the first display electrode layer includes n first display electrodes 21, and n is a positive integer greater than 1. The first display electrodes 21 are in one-to-one correspondence with the first touch electrodes 31, that is, a first display electrode 211 corresponds to the first touch electrode 311 so that the first display electrode 211 and the first touch electrode 311 form one overlapping electrode group; a first display electrode 212 and the first touch electrode 312 form one overlapping electrode group, a first display electrode 213 and a first touch electrode 313 form one overlapping electrode group, and so on, a first display electrode 21n−1 and a first touch electrode 31n−1 form one overlapping electrode group, and a first display electrode 21n and a first touch electrode 31n form one overlapping electrode group. In this case, the touch stage Tt may include n touch sub-stages (Tt1, Tt2, Tt3, ..., Ttn−1, and Ttn). In the first touch sub-stage Tt1, the first display electrode 211 receives a first touch signal Vtx11, and the first touch electrode 311 receives a second touch signal Vtx201 so that after the first display electrode 211 and the first touch electrode 311 overlap to form a coupling capacitor, the first touch signal Vtx11 and the second touch signal Vtx201 that are coupled by the coupling capacitor can be mutually canceled, thereby preventing the first touch signal Vtx11 from affecting a signal on the first touch electrode 311 and preventing the second touch signal Vtx201 from affecting a signal on the first display electrode 211. Similarly, in the second touch sub-stage Tt2, the first display electrode 212 receives a first touch signal Vtx12, and the first touch electrode 312 receives a second touch signal Vtx202 so that the coupling amount of the first touch signal Vtx12 and the coupling amount of the second touch signal Vtx202 can be mutually canceled; in the third touch sub-stage Tt3, the first display electrode 213 receives a first touch signal Vtx13, and the first touch electrode 313 receives a second touch signal Vtx203 so that the coupling amount of the first touch signal Vtx13 and the coupling amount of the second touch signal Vtx203 can be mutually canceled; and so on, in the (n−1)-th touch sub-stage Ttn−1, the first display electrode 21n−1 receives a first touch signal Vtx1n−1, and the first touch electrode 31n−1 receives a second touch signal Vtx20n−1 so that the coupling amount of the first touch signal Vtx1n−1 and the coupling amount of the second touch signal Vtx20n−1 can be mutually canceled; in the nth touch sub-stage Ttn, the first display electrode 21n receives a first touch signal Vtx1n, and the first touch electrode 31n receives a second touch signal Vtx20n so that the coupling amount of the first touch signal Vtx1n and the coupling amount of the second touch signal Vtx20n can be mutually canceled.

In this embodiment, the first display electrode layer is divided into the multiple first display electrodes, overlapping first display electrodes and first touch electrodes form overlapping electrode groups, and in the same overlapping electrode group, the duration for the first display electrode to receive the first touch signal overlaps the duration for the first touch electrode to receive the second touch signal. Thus, in the overlapping duration, the coupling amount of the first touch signal of the first display electrode and the coupling amount of the second touch signal of the first touch electrode in the same overlapping electrode group can be ensured to be mutually canceled so that the accuracy of the signals on the first display electrode and the first touch electrode can be ensured, thereby improving the touch sensitivity and accuracy, the display light-emitting accuracy, as well as the display effect of the touch display panel.

It is to be understood that the duration for the first touch electrode to receive the second touch signal overlaps the duration for the first display electrode to receive the first touch signal in the same overlapping electrode group, that is, the first display electrode receives the first touch signal in at least part of the duration for the first touch electrode to receive the second touch signal. In this case, the start moment for the first touch electrode to receive the second touch signal may be the same as or different from the start moment for the first display electrode to receive the first touch signal, and the end moment for the first touch electrode to receive the second touch signal may be the same as or different from the end moment for the first display electrode to receive the first touch signal, which may be specifically designed according to actual requirements and are not specifically limited in the embodiments of the present disclosure.

In an embodiment, referring to FIGS. 20, 22, and 23, in the touch stage Tt, in the same overlapping electrode group, the start moment for supplying the second touch signal VTX2to the first touch electrode 31and the start moment for supplying the first touch signal VTX1to the first display electrode 21are the same moment t1.

The start moment of the first touch signal VTX1 may be understood as the moment when the first power signal is stopped from being supplied to the first display electrode 21, and the first touch signal VTX1 is started to be supplied to the first display electrode 21. Similarly, the start moment of the second touch signal VTX2 may be understood as the moment when the second power signal is stopped from being supplied to the first touch electrode 31, or the first touch electrode 31 stops being in a suspended state, and the second touch signal VTX2 is started to be supplied to the first touch electrode 31. In the same overlapping electrode group, the start moment for the first touch electrode 31 to receive the second touch signal VTX2 and the start moment for supplying the first touch signal VTX1 to the first display electrode 21 are arranged as the same moment so that the signal hopping moment of the first touch electrode 31 and the signal hopping moment of the first display electrode 21 in the same overlapping electrode group can be the same moment, and so that the coupling amounts generated by signal hoppings can be mutually canceled, thereby improving the touch sensitivity and accuracy and improving the accuracy of the display light-emitting brightness.

In another embodiment, referring to FIGS. 20, 24, and 25 in the touch stage, in the same overlapping electrode group, the end moment for supplying the second touch signal to the first touch electrode and the end moment for supplying the first touch signal to the first display electrode are the same moment.

The end moment of the first touch signal VTX1 may be understood as the moment when the first touch signal VTX1 is stopped from being supplied to the first display electrode 21, and the first power signal is started to be supplied to the first display electrode 21. Similarly, the end moment of the second touch signal VTX2 may be understood as the moment when the second touch signal VTX2 is stopped from being supplied to the first touch electrode 31, the second power signal is started to be supplied to the first touch electrode 31, or the first touch electrode 31 starts to be in a suspended state. In the same overlapping electrode group, the end moment for the first touch electrode 31 to receive the second touch signal VTX2 and the end moment for supplying the first touch signal VTX1 to the first display electrode 21 are arranged as the same moment so that the signal hopping moment of the first touch electrode 31 and the signal hopping moment of the first display electrode 21 in the same overlapping electrode group can be the same moment, and so that the coupling amounts generated by signal hoppings can be mutually canceled, thereby improving the touch sensitivity and accuracy and improving the accuracy of the display light-emitting brightness.

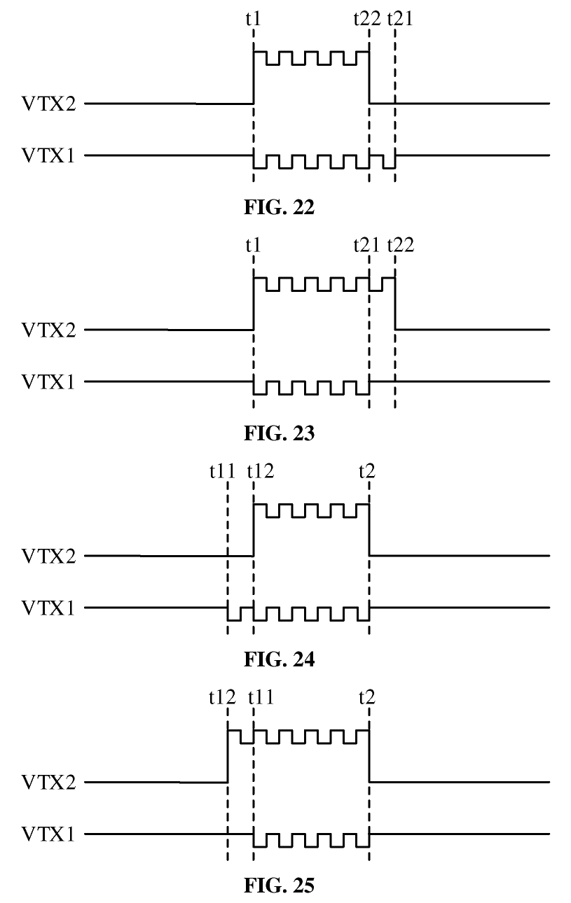

It is to be understood that when the start moment of the second touch signal VTX2 of the first touch electrode and the start moment of the first touch signal VTX1 of the first display electrode in the same overlapping electrode group are the same moment, the end moment t22 of the second touch signal VTX2 of the first touch electrode may be located before the end moment t21 of the first touch signal VTX1 of the first display electrode (as shown in FIG. 23), or the end moment t22 of the second touch signal VTX2 of the first touch electrode may be located after the end moment t21 of the first touch signal VTX1 of the first display electrode (as shown in FIG. 22), or the end moment of the second touch signal VTX2 of the first touch electrode and the end moment of the first touch signal VTX1 of the first display electrode are also the same moment (as shown in FIG. 21). Correspondingly, when the end moment of the second touch signal VTX2 of the first touch electrode and the end moment of the first touch signal VTX1 of the first display electrode in the same overlapping electrode group are the same moment, the start moment t12 of the second touch signal VTX2 of the first touch electrode may be located before the start moment t11 of the first touch signal VTX1 of the first display electrode (as shown in FIG. 25), or the start moment t12 of the second touch signal VTX2 of the first touch electrode may be located after the start moment t11 of the first touch signal VTX1 of the first display electrode (as shown in FIG. 24), or the start moment of the second touch signal VTX2 of the first touch electrode and the start moment of the first touch signal VTX1 of the first display electrode are also the same moment (as shown in FIG. 21). The duration of overlapping the first touch signal VTX1 and the second touch signal VTX2 may be designed according to actual requirements and is not specifically limited in the embodiments of the present disclosure.

On the basis of the preceding embodiments, referring to FIG. 20, when the first display electrode layer includes the multiple first display electrodes 21, the first display electrodes can be electrically connected to first signal terminals O1 through corresponding signal lines respectively so that the first signal terminals O1 can supply first touch signals VTX1 to the first display electrodes 21 respectively in the touch stage, and the first touch signals VTX1 supplied by the first signal terminals O1 do not interfere with each other, ensuring that, in the same overlapping electrode group, the duration for the first display electrode 21 to receive the first touch signal VTX1 can overlap the duration for the first touch electrode 31 to receive the second touch signal VTX2 to cancel the signal coupling amount of the first touch signal VTX1 and the signal coupling amount of the second touch signal VTX2.

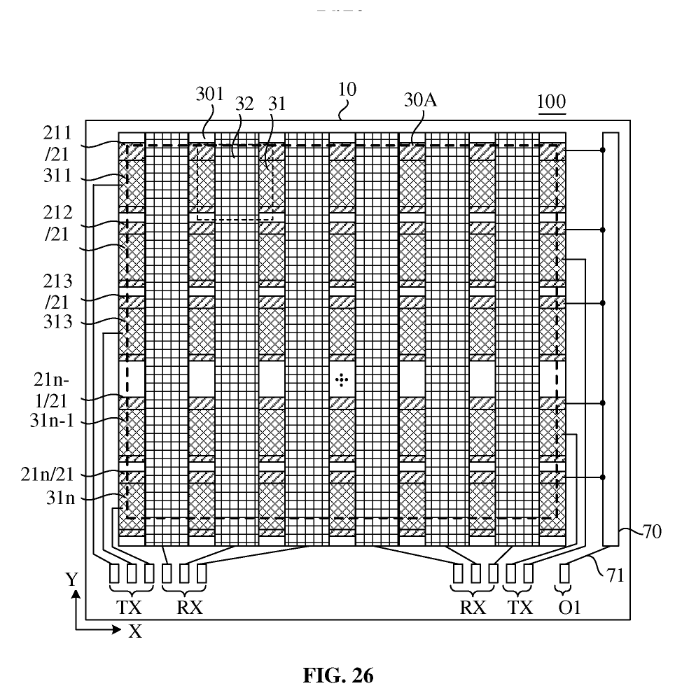

On the basis of the preceding embodiments, referring to FIG. 26, the touch display panel 100 may further include a first signal transmission line 71 and a signal control circuit 70; the signal control circuit 70 is electrically connected to the first signal transmission line 71 and the first display electrodes 21; the first signal transmission line 71 is configured to transmit the first touch signal VTX1 in the touch stage.

The signal control circuit 70 may include a signal input terminal and multiple signal output terminals in one-to-one correspondence with the first display electrodes 21. For the signal control circuit 70, the signal input terminal may be electrically connected to the first signal transmission line 71, and the signal output terminals may be electrically connected to the first display electrodes 21 in one-to-one correspondence. The signal control circuit 70 can control the conductive path between the signal input terminal and the signal output terminals, so as to control the duration for supplying the first touch signal VTX1 transmitted by the first signal transmission line 71 to the first display electrodes 21 so that the first touch signal VTX1 received by the first display electrode 21 and the second touch signal VTX2 received by the first touch electrode 31 can be mutually cancelled, where the first display electrode 21 overlaps the first touch electrode 31, thereby improving the touch sensitivity and accuracy and improving the display light-emitting accuracy.

In addition, the first signal transmission line 71 may further be electrically connected to a first signal terminal O1. In this case, only one first signal terminal O1 is required to provide the first touch signal VTX1 in the touch stage, which can help reduce the number of first signal terminals O1 provided in the touch display panel, simplify the structure, and reduce costs.

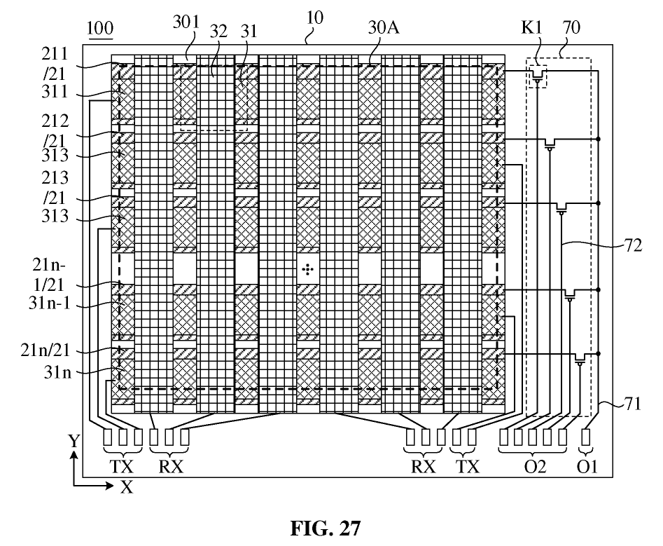

On the basis of the preceding embodiments, referring to FIG. 27, the touch display panel 100 may further include multiple switch control lines 72; the signal control circuit 70 includes multiple control switches K1 respectively corresponding to the first display electrodes 21; input terminals of the control switches K1 are electrically connected to the first signal transmission line 71, output terminals of the control switches K1 are electrically connected to the first display electrodes 21 respectively, and control terminals of the control switches K1 are electrically connected to the switch control lines 72 respectively.

The switch control lines 72 can be configured to transmit switch control signals so that the switch control signals can control the control switches K1 to turn on or off, and when the control switches K1 are in the on state, the first touch signal VTX1 transmitted by the first signal transmission line 71 in the touch stage can be supplied to the first display electrodes 21 electrically connected to the control switches K1. Otherwise, when the control switches K1 are in the off state, the first signal transmission line 71 cannot transmit the first touch signal VTX1 to the first display electrodes 21 in the touch stage. In this manner, the control switches K1 respectively electrically connected to the first display electrodes 21 in different overlapping electrode groups are controlled to turn on in a time-division manner, that is, the switch control lines 72 transmit valid levels of the switch control signals in a time-division manner, so that the first touch signal VTX1 can be supplied to the first display electrodes 21 in a time-division manner, thereby ensuring that the signal coupling amount of the first touch signal VTX1 and the signal coupling amount of the second touch signal VTX2 can be mutually canceled and further ensuring the sensitivity and accuracy of touch detection and the accuracy of the display light-emitting brightness.

In addition, the touch display panel 100 may further be provided with multiple second signal terminals O2 respectively corresponding to the switch control lines 72, and the second signal terminals O2 provide the switch control signals to the switch control lines 72 respectively so that in the touch stage, the switch control signals transmitted by the switch control lines 72 can control the control switches K1 to turn on in a time-division manner, and the first touch signal VTX1 can be then supplied to the first display electrodes 21 in a time-division manner. Correspondingly, in the display stage, when the first display electrodes 21 receives the same first power signal, the switch control lines 72 can transmit the same control signal to control the control switches K1 to turn on at the same time so that the first display electrodes 21 can receive the first power signal at the same time, thereby ensuring the signal consistency on the first display electrodes 21 in the display stage.

It is to be understood that, under the premise that the control switches can control the duration for supplying the first touch signal to the first display electrodes, the structure of a control switch of the control switches may be designed according to actual requirements, and the embodiments of the present disclosure have different limitations on the specific structure of the control switch. In an embodiment, the control switch may include a switch transistor, a gate of the switch transistor may be electrically connected to a switch control line, a first electrode of the switch transistor may be electrically connected to the first signal transmission line, and a second electrode of the switch transistor may be electrically connected to a first display electrode. A switch control signal transmitted by the switch control line can control the switch transistor to turn on or off, thereby controlling the conductive path between the first signal transmission line and the first display electrode.

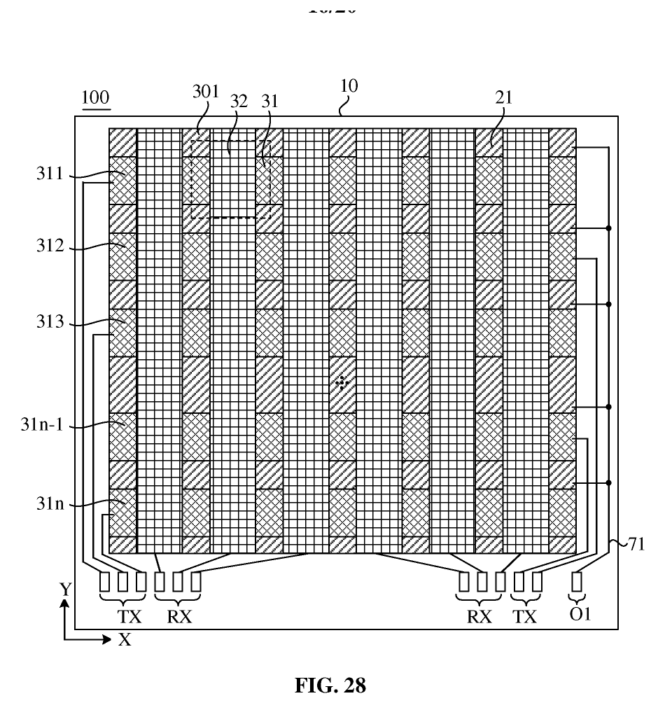

In other embodiments, referring to FIG. 28, when the display function layer includes the first display electrode layer, and the first display electrode layer includes the first display electrodes 21, the first display electrodes 21 of the display units may form an integrated structure; the touch display panel 100 further includes the first signal transmission line 71. The first display electrodes 21 are electrically connected to the first signal transmission line 71, and the first signal transmission line 71 is at least configured to transmit the first touch signal VTX1 in the touch stage.

The first signal transmission line 71 may further be electrically connected to the first signal terminal O1 so that the first signal transmission line 71 can transmit a signal supplied by the first signal terminal O1 to the first display electrodes 21, and so that the first display electrodes 21 of the display units can simultaneously receive the same signal, thereby ensuring that the first display electrodes 21 of the display units can simultaneously receive the first touch signal VTX1 in the touch stage and the first power signal in the display stage and further ensuring the signal consistency on the first display electrodes 21 of the display units.

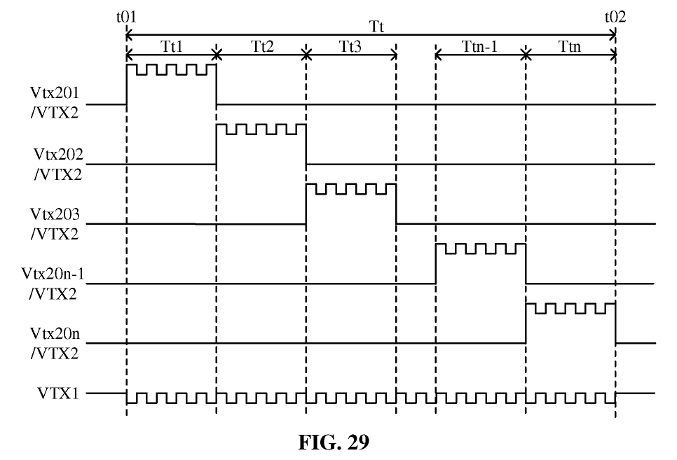

On the basis of the preceding embodiments, referring to FIGS. 28 and 29, the start moment t01 of the alternating current signal of the first touch signal VTX1 is the start moment of the touch stage Tt; and/or, the end moment t02 of the alternating current signal of the first touch signal VTX1 is the end moment of the touch stage Tt.

The start moment t01 of the alternating current signal of the first touch signal VTX1 may be understood as the moment when the first touch signal VTX1 stops being maintained as the first power signal and starts to periodically vary between the first amplitude and the second amplitude. Similarly, the end moment t02 of the alternating current signal of the first touch signal VTX1 may be understood as the moment when the first touch signal VTX1 stops periodically varying between the first amplitude and the second amplitude and starts to become the fixed first power signal.

Between the start moment and the end moment of the touch stage Tt, the second touch signal Vtx201, which is an alternating current signal, is sequentially supplied to first touch electrodes 311 to 31n, which are arranged from the first position to the last position in the same first touch electrode group. The start moment t01 for supplying the alternating current signal of the first touch signal VTX1 to the first display electrode 21 and the start moment of the touch stage Tt are arranged as the same moment so that at least at the start moment of the touch stage Tt, a coupling signal generated by the hopping of the second touch signal Vtx21 received by the first touch electrode 311 and a coupling signal generated by the hopping of the first touch signal VTX1 received by the first display electrode 21 can be mutually cancelled. The end moment t02 for supplying the alternating current signal of the first touch signal VTX1 to the first display electrode 21 and the end moment of the touch stage Tt are arranged as the same moment so that at least at the end moment of the touch stage Tt, a coupling signal generated by the hopping of the second touch signal Vtx21 received by the first touch electrode 31n and the coupling signal generated by the hopping of the first touch signal VTX1 received by the first display electrode 21 can be mutually cancelled. This arrangement helps improve the touch sensitivity and accuracy of the touch display panel and the display light-emitting accuracy of the display unit.

Based on the same inventive concept, the embodiments of the present disclosure further provide a display device. The display device includes the touch display panel provided in the embodiments of the present disclosure, so the display device has the technical features of the touch display panel provided in the embodiments of the present disclosure and can achieve the beneficial effects of the touch display panel provided in the embodiments of the present disclosure. For similarities, reference may be made to the preceding description of the touch display panel, and details are not repeated herein.

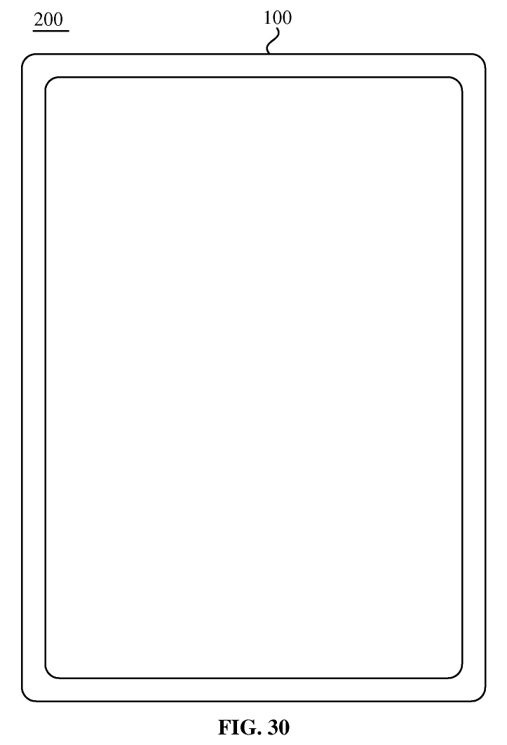

Exemplarily, FIG. 30 is a diagram illustrating the structure of a display device according to embodiments of the present disclosure. As shown in FIG. 30, the display device 200 includes the touch display panel 100. The display device 200 may include, but is not limited to, a mobile phone, a television, a laptop, a desktop display, a tablet computer, a digital camera, a smart bracelet, smartglasses, a vehicle-mounted display, medical equipment, industrial control equipment, and a touch interactive terminal. No special limitations are made thereto in the embodiments of the present disclosure.

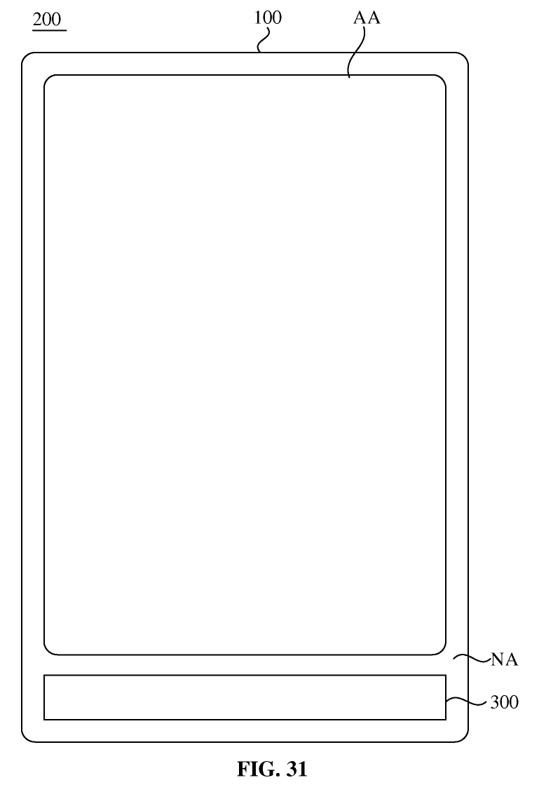

On the basis of the preceding embodiments, referring to FIG. 31, the display device 200 further includes a driving circuit 300. The driving circuit 300 is configured to supply the first touch signal to the first display electrodes of the touch display panel 100 and supply the second touch signal to the first touch electrodes of the touch display panel 100 in the touch stage. The driving circuit 300 is further configured to supply the first power signal to the first display electrodes in the display stage. The first touch signal and the second touch signal each include the alternating current signal; the first power signal is the direct current signal.

The touch display panel 100 may include a display region AA and a non-display region NA at least partially surrounding the display region AA. The non-display region NA may include a driving circuit arrangement region, and the driving circuit arrangement region may be configured to arrange the driving circuit 300. The driving circuit 300 can supply the first power signal to the first display electrodes of the display units in the display stage so that the display units can display light emission at least under the control of the first power signal. Moreover, the driving circuit 300 can further supply the first touch signal to the first display electrodes of the display units and supply the second touch signal to the first touch electrodes in the touch stage so that the coupling amount from the first touch signal received by the first display electrodes to the first touch electrodes can be cancelled by the coupling amount from the second touch signal received by the first touch electrodes to the first display electrodes, thereby ensuring the touch sensitivity and accuracy of the touch display panel and improving the display effect of the touch display panel.

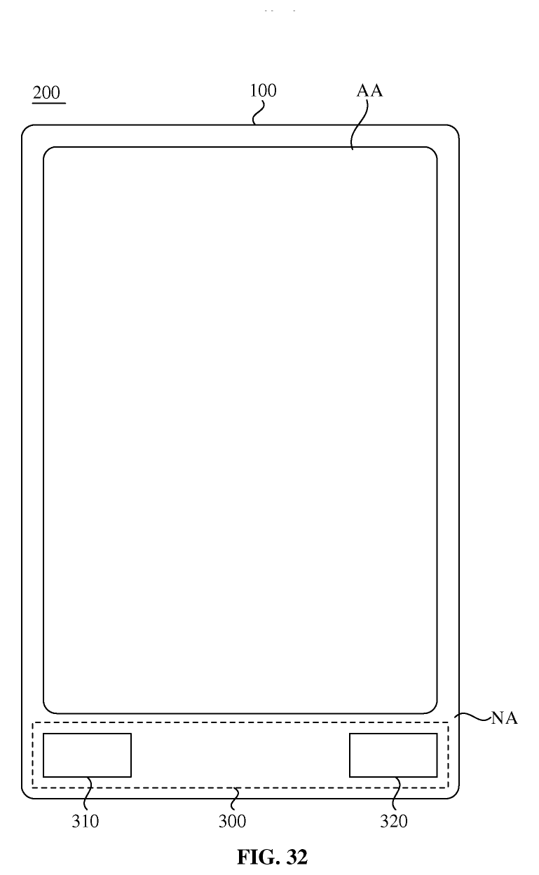

In an embodiment, as shown in FIG. 32, the driving circuit 300 may include a touch driver chip 310 and a power management chip 320. In this case, the touch driver chip 310 and the power management chip 320 can supply different signals respectively to drive each touch unit to fulfill the touch function in the touch stage and to drive each display unit to display light emission in the display stage.

In an embodiment, the touch driver chip 310 can be electrically connected only to the touch units so that the touch driver chip 310 can supply the second touch signal to the first touch electrodes of the touch units in the touch stage and receive the touch sensing signals fed back by the touch units, thereby determining the touch position of a touch region according to the supplied second touch signal and the received touch sensing signals. The power management chip 320 can be electrically connected to the display units so that the power management chip can supply the first power signal to the first display electrodes of the display units in the display stage and supply the first touch signal to the first display electrodes of the display units in the touch stage. In this manner, the touch driver chip 310 can only control the signal in the touch units, and the power management chip 320 can only control the signal in the display units so that the touch driver chip 310 and the power management chip 320 each can have a small load, thereby improving the touch driving accuracy of the touch driver chip 310 and the display control accuracy of the power management chip 320.

In another embodiment, the touch driver chip 310 can be electrically connected to the touch units and the display units so that in the touch stage, the touch driver chip 310 can supply the first touch signal to the first display electrodes of the display units, supply the second touch signal to the first touch electrodes of the touch units, and receive the touch sensing signals fed back by the touch units, thereby ensuring the touch sensitivity and display accuracy under the premise that the touch position of the touch object can be determined according to the second touch signal and the touch sensing signals to fulfill the touch function. The power management chip 320 can be electrically connected only to the display units so that the power management chip 320 can at least supply the first power signal to the first display electrodes of the display units in the display stage, thereby ensuring that the display units can accurately display light emission in the display stage. In this manner, in the display stage, the power management chip 320 can be in an operation state to supply the first power signal to the display units, and in the touch stage, the touch driver chip 310 can be in an operation state to supply the first touch signal to the display units and supply the second touch signal to the first touch electrodes, thereby reducing the number of chips operating in the display stage and the number of chips operating in the touch stage, and further contributing to low power consumption of the display device.

In addition, the driving circuit 300 may further include a display driver chip. The display driver chip may be configured to supply a display control signal to the display units in the display stage. The display control signal includes, but is not limited to, a data signal, a reset signal, an initialization signal, or a clock signal, to drive the display units to display light emission. The display driver chip and the touch driver chip 310 may be integrated into the same chip or may also be different chips, which may be specifically designed according to actual requirements and is not specifically limited in the embodiments of the present disclosure.

It is to be noted that the preceding are only preferred embodiments of the present disclosure and the technical principles used therein. It is to be understood by those skilled in the art that the present disclosure is not limited to the embodiments described herein. For those skilled in the art, various apparent modifications, adaptations, and substitutions can be made without departing from the scope of the present disclosure. Therefore, while the present disclosure is described in detail in connection with the preceding embodiments, the present disclosure is not limited to the preceding embodiments and may include equivalent embodiments without departing from the concept of the present disclosure. The scope of the present disclosure is determined by the scope of the appended claims.

What is claimed is:

1. A touch display panel, comprising: a base substrate, a display function layer and a touch function layer that are located on one side of the base substrate,
wherein the display function layer comprises a plurality of display units arranged in an array, and a display unit of the plurality of display units comprises a first display electrode;
wherein the touch function layer comprises a plurality of touch units, and a touch unit of the plurality of touch units comprises a first touch electrode;
wherein an operation process of the touch display panel at least comprises a touch stage; and
wherein, in the touch stage, the plurality of first display electrodes of the plurality of display units receive a first touch signal, and the plurality of first touch electrodes of the plurality of touch units receive a second touch signal; the first touch signal and the second touch signal each comprise an alternating current signal.

2. The touch display panel of claim 1, wherein the first touch signal and the second touch signal have opposite polarities.

3. The touch display panel of claim 1, wherein at a same moment in the touch stage, an amplitude of the first touch signal is V1, and an amplitude of the second touch signal is V2, wherein V1 = −V2.

4. The touch display panel of claim 1, wherein the operation process of the touch display panel further comprises a display stage; and
in the display stage, the plurality of first display electrodes of the plurality of display units receive a first power signal, and the first power signal is a direct current signal.

5. The touch display panel of claim 4, wherein the first power signal has a same polarity as the first touch signal.

6. The touch display panel of claim 1, wherein the touch function layer comprises a first touch electrode layer, and the first touch electrode layer comprises the plurality of first touch electrodes;
the plurality of first touch electrodes form at least one first touch electrode group; and
in the touch stage, the first touch electrodes in a same first touch electrode group receive the second touch signal in a time-division manner.

7. The touch display panel of claim 6, wherein the display function layer comprises a first display electrode layer, and the first display electrode layer comprises the plurality of first display electrodes respectively corresponding to the plurality of first touch electrodes;
in a direction perpendicular to a plane on which the base substrate is located, among the plurality of first touch electrodes and the plurality of first display electrodes, a first touch electrode overlaps a first display electrode corresponding to the first touch electrode to form one overlapping electrode group; and
in the touch stage, in the same overlapping electrode group, a duration for the first touch electrode to receive the second touch signal overlaps a duration for the first display electrode to receive the first touch signal.

8. The touch display panel of claim 7, wherein in the touch stage, in the same overlapping electrode group, a start moment for supplying the second touch signal to the first touch electrode and a start moment for supplying the first touch signal to the first display electrode are a same moment.

9. The touch display panel of claim 7, wherein in the touch stage, in the same overlapping electrode group, an end moment for supplying the second touch signal to the first touch electrode and an end moment for supplying the first touch signal to the first display electrode are a same moment.

10. The touch display panel of claim 7, further comprising a first signal transmission line and a signal control circuit,
wherein the signal control circuit is electrically connected to the first signal transmission line and the plurality of first display electrodes, and the first signal transmission line is configured to transmit the first touch signal in the touch stage.

11. The touch display panel of claim 10, further comprising a plurality of switch control lines,
wherein the signal control circuit comprises a plurality of control switches respectively corresponding to the plurality of first display electrodes; and
wherein input terminals of the plurality of control switches are electrically connected to the first signal transmission line, output terminals of the plurality of control switches are electrically connected to the plurality of first display electrodes respectively, and control terminals of the plurality of control switches are electrically connected to the plurality of switch control lines respectively.

12. The touch display panel of claim 1, wherein the touch unit further comprises a second touch electrode; and
in the touch stage, the plurality of second touch electrodes of the plurality of touch units output touch sensing signals in sequence.

13. The touch display panel of claim 1, further comprising a first signal transmission line,
wherein the display function layer comprises a first display electrode layer, and the first display electrode layer comprises the plurality of first display electrodes;
wherein the plurality of first display electrodes of the plurality of display units form an integrated structure, and the plurality of first display electrodes are electrically connected to the first signal transmission line; and
wherein the first signal transmission line is at least configured to transmit the first touch signal in the touch stage.

14. The touch display panel of claim 13, wherein a start moment of the alternating current signal of the first touch signal is a start moment of the touch stage; and/or
an end moment of the alternating current signal of the first touch signal is an end moment of the touch stage.

15. The touch display panel of claim 1, wherein the display function layer comprises a driving circuit layer and a light-emitting function layer located on one side of the driving circuit layer facing away from the base substrate;
the driving circuit layer comprises a plurality of pixel circuits arranged in an array, and the light-emitting function layer comprises a plurality of light-emitting elements; among the plurality of light-emitting elements, a light-emitting element comprises a first display electrode of the plurality of first display electrodes, a second display electrode of a plurality of second display electrodes, and a light-emitting layer located between the first display electrode and the second display electrode; and
the plurality of pixel circuits are electrically connected to the plurality of second display electrodes respectively, and the plurality of pixel circuits and the plurality of light-emitting elements that are connected respectively form the plurality of display units.

16. A display device, comprising a touch display panel,
wherein the touch display panel comprises a base substrate, a display function layer and a touch function layer that are located on one side of the base substrate,
wherein the display function layer comprises a plurality of display units arranged in an array, and a display unit of the plurality of display units comprises a first display electrode;
wherein the touch function layer comprises a plurality of touch units, and a touch unit of the plurality of touch units comprises a first touch electrode;
wherein an operation process of the touch display panel at least comprises a touch stage; and
wherein, in the touch stage, the plurality of first display electrodes of the plurality of display units receive a first touch signal, and the plurality of first touch electrodes of the plurality of touch units receive a second touch signal; the first touch signal and the second touch signal each comprise an alternating current signal.

17. The display device of claim 16, further comprising a driving circuit,
wherein the driving circuit is configured to supply the first touch signal to the plurality of first display electrodes of the touch display panel and supply the second touch signal to the plurality of first touch electrodes of the touch display panel in the touch stage;
wherein the driving circuit is further configured to supply a first power signal to the plurality of first display electrodes in a display stage; and
wherein the first touch signal and the second touch signal each comprise an alternating current signal, and the first power signal is a direct current signal.

18. The display device of claim 17, wherein the driving circuit comprises a touch driver chip and a power management chip;
the power management chip is configured to supply the first power signal to the plurality of first display electrodes in the display stage and supply the first touch signal to the plurality of first display electrodes in the touch stage; and
the touch driver chip is configured to supply the second touch signal to the plurality of first touch electrodes in the touch stage.

19. The display device of claim 17, wherein the driving circuit comprises a touch driver chip and a power management chip;
the power management chip is configured to supply the first power signal to the plurality of first display electrodes in the display stage; and
the touch driver chip is configured to supply the first touch signal to the plurality of first display electrodes and supply the second touch signal to the plurality of first touch electrodes in the touch stage.
